(19) United States
(12) Patent Application Publication
(10) Pub. No.: US 2019/0354762 A1
(43) Pub. Date: Nov. 21, 2019

(54) METHOD AND DEVICE FOR TIME LAPSED DIGITAL VIDEO RECORDING AND NAVIGATION THROUGH THE SAME

(71) Applicant: Chandru Bolaki, San Ramon, CA (US)

(72) Inventor: Chandru Bolaki, San Ramon, CA (US)

(21) Appl. No.: 15/981,990

(22) Filed: May 17, 2018

(51) Int. Cl. G06K 9/00; H04N 21/845; H04N 5/232; H04N 21/422

(52) U.S. Cl. CPC G06K 9/00718; H04N 21/8456; G06K 2009/00738; H04N 21/42201; H04N 5/23258

(57) ABSTRACT

The various embodiments herein provide a method for creating a navigable time lapsed digital video content. Firstly, a plurality of images are taken in a time lapsed format of a plurality of events through a portable device. Simultaneously, the plurality of events are recorded in a digital video format through the portable device. The digitally recorded video runs in synchronization with the time lapsed pictures. During capturing the images, a plurality of temporal point of interest (POIs) are identified and saved in the time lapsed pictures while a date and time stamp is attached with each frame in the images and also the temporal point of interests. Further, the time lapsed pictures are mapped with the digitally recorded video.

### BACKGROUND

### Technical Field of Invention

The embodiments herein generally relate to a data acquisition and navigation technique and particularly relates to a method and device for a time lapsed video recording having temporal point of interests as a marker. The present invention more particularly relates to a method and device for creation of time lapsed video through a recorded content and navigating through the time lapsed video on the basis of user inputs.

### Description of Related Art

A time-lapse photography is a technique in which a frequency at which film frames are captured (the frame rate) is much lower than that used to view the sequence. When played at normal speed, the time appears to be moving faster and thus lapsing. Although, the time lapsing provides a view of actions taken place during a larger time period in a shorter frame period.

Since the inception of the time lapsing technique a plurality of prior arts have been adapted to provide enhanced features in a time lapsed video. One of such prior arts discloses a method for creating a time lapsed video of frames selected around temporal point of interests. The frame rate is varied as per occurrence and duration of temporal points of interests. Although, the temporal point of interests in this prior art are limited to luminance, colour exposure and white balance. Further, the time lapsed video disclosed in the prior art does not allow navigation from a user selectable input.

Another prior art discloses an apparatus comprising a plurality of security cameras, a monitoring processor that tracks a focus of attention of a user via selection of cameras one at a time from among the plurality of security cameras, a collection processor that detects an evidence collection request from the user, opens an evidence file in response thereto and saves a sequence of video files from at least some of the plurality of video cameras into the evidence file based upon the tracked focus of attention of the user. The prior art shows a digitally recorded video and a navigation through the same by selection of video parameters. However, the digitally recorded video is limited in identification and marking of a plurality of parameters like a user action, an ambient condition, a light exposure etc. Thus, the prior art is rendered inaccurate if the navigational inputs comprises of above parameters.

In the view of foregoing, there is a need for a method and a device for creating a time lapsed digital video with navigational feasibility on the basis of a plurality of parameters. Also, there is a need for a method for embedding a plurality of temporal points of interests to generate an alert during a real-time as well as during a playback.

The above-mentioned shortcomings, disadvantages and problems are addressed herein, as detailed below.

### SUMMARY OF THE INVENTION

The primary objective of the embodiments herein is to provide a method and a device for creating a time lapsed digital video with navigational feasibility on the basis of a plurality of parameters.

Another objective of the embodiment herein is to provide a method for embedding a plurality of temporal points of interests to generate an alert during a real-time as well as during a playback.

Yet another objective of the embodiments herein is to provide a method for mapping a time lapsed file over a digitally recorded video. The time lapsed file comprises a plurality of temporal point of interests detected and recorded with a time stamp of occurrence.

The various embodiments herein provide a method for creating a navigable time lapsed digital video content. Firstly, a plurality of images of a plurality of events are captured through a portable device. The plurality of images are sequentially stitched together to form a time lapsed video. Simultaneously, the plurality of events are recorded in a digital video format through the portable device. During capturing the images, a plurality of temporal point of interest (POIs) are identified and saved in the time lapsed pictures while a date and time stamp is attached with each frame in the images and also the temporal point of interests. Further, the time lapsed pictures are mapped with the digitally recorded video.

According to one embodiment of the present invention, the temporal POIs are determined by a plurality of sensors comprising an imaging unit, a pressure sensor, a temperature sensor, a motion sensor, a humidity sensor and a light sensor. The temporal POIs comprise a human face, a motion, a temperature, a humidity, a light and a sound.

According to one embodiment of the present invention, the motion comprises a normal motion and a suspicious motion. The suspicious motion comprises a rapid movement of a subject, an inception of a hazardous object and an intruder movement detection.

According to one embodiment of the present invention, the temporal POIs are stored in the time lapsed pictures as event markers under a date and time stamp.

According to one embodiment of the present invention, the time lapsed picture is created by converting the plurality of images taken by the portable device. A JSON file is created according to a name of a time-lapse image. The plurality of images are arranged in frames. Then, a plurality of event markers are identified and saved in each frame attached with a date and time stamp. The plurality of frames in JSON file format are stitched together in an incremental time order to form a time lapsed video and each frame in the time lapsed video is saved with a frame-time.

According to one embodiment of the present invention, a playback of the DVR is navigable in a hierarchical order. The hierarchical order comprises a selection of a date of frame, a time of the frame and a temporal POI.

According to one embodiment of the present invention, the temporal POIs trigger an alert in a real time as well as during playback.

According to one embodiment of the present invention, a device for creating a time lapsed DVR comprises a processing unit, an imaging unit, a video recording unit, a plurality of sensors, and a computer readable program. The imaging unit captures an event frame-wise within a field of sight. The video recording unit captures a digital video of the event within the field of sight. The plurality of sensors, the imaging unit and the video recording unit are connected to the processing unit. A temporal POI detected by the plurality of sensors is embedded to a frame taken at same time. The computer readable program stitches the frames in periodically hierarchical order and maps the stitched event frame with the digital video recording.

According to one embodiment of the present invention, the digitally recorded video is navigable in a hierarchical order. The hierarchical order comprises a selection of a date of frame, a time of the frame and a temporal POI.

According to one embodiment of the present invention, the digitally recorded video is navigable through an input of a temporal POI in a search criteria during a video playback.

These and other aspects of the embodiments herein will be better appreciated and understood when considered in conjunction with the following description and the accompanied drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanied drawings in which:

FIG. 1 illustrates a flowchart for a method of creating a navigable time lapsed digital video, according to one embodiment herein.

FIG. 2 illustrates a flowchart for a method of a navigating through the time lapsed digital video, according to one embodiment herein.

FIG. 3 illustrates a flowchart for a method of switching between a time-lapsed video and a digitally recorded video, according to one embodiment herein.

FIG. 4 illustrates a block diagram of a device for digital video recording and a time lapsed image capture, according to one embodiment herein.

### DETAILED DESCRIPTION OF THE DRAWINGS

In the following detailed description, a reference is made to the accompanied drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

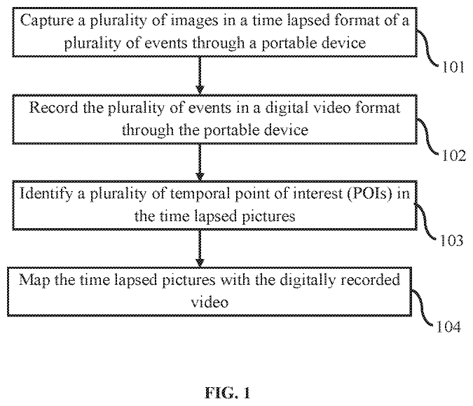

FIG. 1 illustrates a flowchart for a method of creating a navigable time lapsed digital video, according to one embodiment herein. With respect to FIG. 1, the method comprises the steps of:
a) capturing a plurality of images of a plurality of events through a portable device. The plurality of images are sequentially stitched together to form a time lapsed video (101). The images are converted into a JavaScript Object Notation (JSON) file format by adding a name of the image to the JSON file and the plurality of image frames are stitched together to form a time lapsed video. The JSON file contains an information to calculate a mapping of a frame in the time lapsed video with the DVR file. A time for each frame is saved along with the JSON as “frame-time” which is in primarily milliseconds i.e. if frame-time is 50 ms then each frame in the JSON file is displayed for 500 ms. The information for mapping comprises a frame-time and a list of stitched images.
b) recording the plurality of events in a digital video format through the portable device (102).
c) identifying a plurality of temporal point of interest (POIs) in the time lapsed pictures (103). A date and time stamp is attached with temporal point of interests;
d) mapping the time lapsed pictures with the digitally recorded video (104).

Using the information, the below given formulae is used for mapping the JSON file with the DVR file:

(Current Playback Time)/(Frame-time)=JSON index DVR file

For example—if current playback time=1400 ms, and a frame-time is 500 ms then 1400/500 is 2 (integral quotient), then a request of the DVR is sent for a time stamp at JSON[2] using a ‘get local’ video call.

According to one embodiment of the present invention, for playing a time-lapsed video file, a user clicks a time-lapse button on the computer readable program. The computer readable program uses a MQTT call, download and parse the JSON file and then start playing the video link. The computer readable program also has playback speed controls for 2×, 4×, 8× playback speeds. The algorithm used in the computer readable program:

- Request
{“msg type”: “get timelapse”, “date” : YYYYMMDD }
- Response
{“msg type”: “VOD”,
“video link”: link.mp4,
“JSON link”: link.JSON}

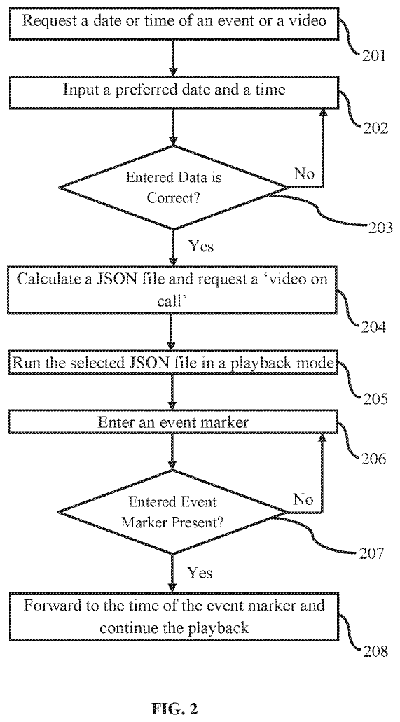

FIG. 2 illustrates a flowchart for a method of a navigating through the time lapsed digital video, according to one embodiment herein. With respect to FIG. 2, the navigation initiates by requesting a date or time of an event or a video (201). The computer readable program prompts for inputting a preferred date or a time or both (202). On entering of correct date and time (203), a JSON file is calculated and a ‘video on call’ requested (204). The selected JSON file is run in a playback mode (205). The user inputs an event marker such as a light change, a sudden temperature change, an intruder detection or a sudden rise in ambient sound through a search index (206). The file checks for event marker in the playback and determines a time stamp (207). The video playback switches or forwards to the searched time stamp of the event marker (208).

Each even marker has a colour coding such as red for temperature, yellow for light, blue for humidity, green for motion, etc. Hence, the user is facilitated to select a colour code that corresponds to an event marker and is taken as input to forward the payback to the time stamp corresponding to the determined even marker.

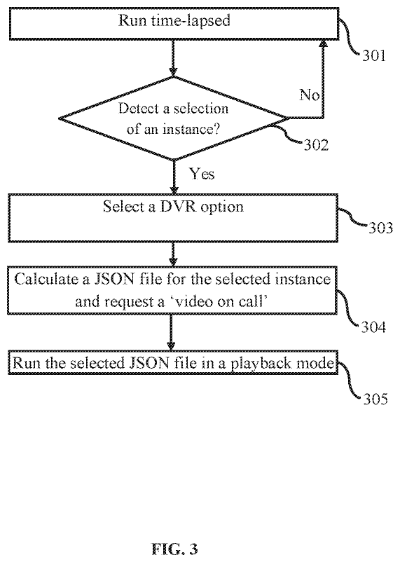

FIG. 3 illustrates a flowchart for a method of switching between a time-lapsed video and a digitally recorded video, according to one embodiment herein. With respect to FIG. 3, a recorded time lapsed video is stitched to the digitally recorded video frame by frame. During paying a time lapsed video (301), a user is facilitated to select a time instance by clicking on the lapsed video (302). On detecting a time instance selection, a user is further to facilitated to switch to a digitally recorded video corresponding to the frame of the selected time instance (303). On receiving an input to switch to the DVR file, a JSON file for a frame of the requested time instance is searched and request for the “video on call” is placed (304). On receiving the “video on call” request, the DVR file is played in a playback mode (305).

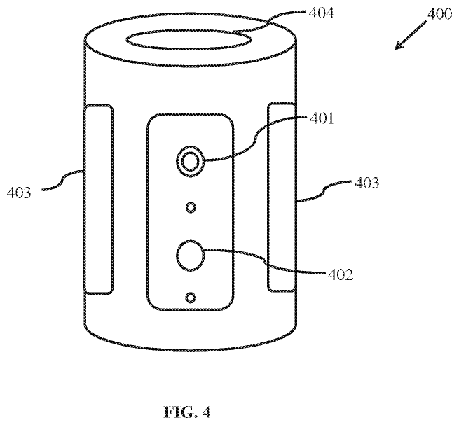

FIG. 4 illustrates a block diagram of a device for digital video recording and a time lapsed image capture, according to one embodiment herein. With respect to FIG. 4, the device 400 comprises a processing unit (not shown), an imaging unit 401, a video recording unit 402, a plurality of sensors 403, and a computer readable program 404. The imaging unit 401 captures an event frame-wise within a field of sight. The video recording unit 402 captures a digital video of the event within the field of sight plurality of sensors, the imaging unit and the video recording unit are connected to the processing unit. A temporal POI detected by the plurality of sensors is embedded to a frame taken at same time. The computer readable program 404 stitches the frames in periodically hierarchical order and maps the stitched event frame with the digital video recording.

The present invention maps the time lapse at the frame level to the digital video recording in order to facilitate a navigation from time lapse to DVR and vice-versa on a user request. Further, the user is facilitated to navigate through the event marker or temporal POIs with reduced reaction time. Also, the time lapse video is converted into a story of the events that happened during a selected day by using a facial and an object recognition.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

I claim:

1. A computer readable method for creating a navigable time lapsed digital video content comprising the steps of:
capturing a plurality of images of a plurality of events through a portable device, wherein the plurality of images are sequentially stitched together to form a time lapsed video;
recording the plurality of events in a digital video format through the portable device;
identifying a plurality of temporal point of interest (POIs) in the time lapsed pictures, wherein a date and time stamp is attached with temporal point of interests;
mapping the time lapsed pictures with the digitally recorded video.

2. The computer readable method according to claim 1, wherein the temporal POIs are determined by a plurality of sensors, wherein the temporal POIs comprise a motion, a temperature, a humidity, a light and a sound.

3. The computer readable method according to claim 2, wherein the motion comprises a normal motion and a suspicious motion, wherein the suspicious motion comprises a rapid movement of a subject, an inception of a hazardous object and an intruder movement detection.

4. The computer readable method according to claim 1, wherein the temporal POIs are stored in the time lapsed pictures as event markers under a date and time stamp.

5. The computer readable method according to claim 1, wherein the time lapsed picture is created by implementation of the steps of:
creating a JSON file by adding a name of the plurality of images taken by the portable
device, wherein the plurality of images are arranged in frames;
identifying and saving a plurality of event markers in each frame;
attaching a date and time stamp to each frame;
stitching the plurality of image frames together in an incremental time order to form a time lapsed video;
wherein, each frame in the time lapsed video is saved with a frame-time.

6. The computer readable method according to claim 5, wherein a playback of the DVR is navigable in a hierarchical order, wherein the hierarchical order comprises a selection of a date of frame, a time of the frame and a temporal POI.

7. The computer readable method according to claim 1, wherein the temporal POIs trigger an alert in a real time as well as during playback.

8. The computer readable method according to claim 1, wherein a device for creating a time lapsed DVR comprises:
an imaging unit, wherein the imaging unit captures an event frame-wise within a field of sight;
a video recording unit, wherein the video recording unit captures a digital video of the event within the field of sight;
a plurality of sensors, wherein the plurality of sensors are connected to the imaging unit, wherein a temporal POI detected by the plurality of sensors are embedded to a frame taken at same time;
a processing unit, wherein plurality of sensors, the imaging unit and the video recording unit are connected to the processing unit; and
a computer readable program, wherein the computer readable program stitches the frames in periodically hierarchical order and maps the stitched event frame with the digital video recording.

9. The computer readable method according to claim 8, wherein the digitally recorded video is navigable in a hierarchical order, wherein the hierarchical order comprises a selection of a date of frame, a time of the frame and a temporal POI.

10. The computer readable method according to claim 8, wherein the digitally recorded video is navigable through an input of a temporal POI in a search criteria during a video playback.
